(19) United States
(12) Patent Application Publication
(10) Pub. No.: US 2020/0349445 A1
(43) Pub. Date: Nov. 5, 2020

(54) DATA PROCESSING SYSTEM AND DATA PROCESSING METHOD

(71) Applicant: OLYMPUS CORPORATION, Tokyo (JP)

(72) Inventor: Yoichi YAGUCHI, Tokyo (JP)

(21) Appl. No.: 16/929,805

(22) Filed: Jul. 15, 2020

Related U.S. Application Data
(63) Continuation of application No. PCT/JP2018/001052, filed on Jan. 16, 2018.

(51) Int. Cl. G06N 3/08; G06N 3/04

(52) U.S. Cl. CPC G06N 3/084; G06N 3/0481

(57) ABSTRACT

A data processing system includes a learning unit that optimizes an optimization target parameter of a neural network on the basis of a comparison between output data that is output by execution of a process according to a neural network on learning data and ideal output data for the learning data. The learning unit optimizes a slope ratio parameter indicating a ratio of a slope when an input value is in a positive range and a slope when the input value is in a negative range in an activation function of the neural network, as one of optimization parameters.

### CROSS-REFERENCE TO RELATED APPLICATIONS

This application is based upon and claims the benefit of priority from International Application No. PCT/JP2018/001052, filed on Jan. 16, 2018, the entire contents of which is incorporated herein by reference.

### BACKGROUND OF THE INVENTION

### 1. Field of the Invention

The present invention relates to a data processing system and a data processing method.

### 2. Description of the Related Art

A neural network is a mathematical model that includes one or more nonlinear units and is a machine learning model that predicts an output corresponding to an input. Many neural networks include one or more intermediate layers (hidden layers) in addition to an input layer and an output layer. The output of each of the intermediate layers is input to the next layer (the intermediate layer or the output layer). Each of layers of the neural network produces an output depending on the input and own parameters.

By using the ReLU function as the activation function, it is possible to alleviate the vanishing gradient problem that makes learning of deep neural networks difficult. Deep neural networks that have become capable of learning have achieved high performance in a wide variety of tasks including image classification by improving their expressiveness.

However, since the ReLU function has a zero gradient for negative input, the gradient vanishes completely at half the expected value, and the learning delays. For the solution, a Leaky ReLU function having a fixed gradient with a slight slope for the negative input has been proposed, which has not yet contributed to the improvement of accuracy.

In addition, there is another proposed function being a PReLU function that uses a gradient for a negative input as an optimization (learning) target parameter, which has achieved accuracy improvement compared to ReLU. However, performing learning of the gradient parameter of PReLU using a gradient might cause the gradient parameter significantly larger than 1. The output of PReLU with such a parameter is divergent, resulting in failure of learning.

### SUMMARY OF THE INVENTION

The present invention has been made in view of such a situation and aims to provide a technique capable of achieving further stable learning with relatively high accuracy.

In order to solve the above problems, a data processing system according to an aspect of the present invention includes a processor including hardware, wherein the processor is configured to: optimize an optimization target parameter of a neural network on the basis of a comparison between output data that is output by execution of a process according to the neural network on learning data and ideal output data for the learning data; optimize a slope ratio parameter indicating a ratio of a slope when the input value is in the positive range and a slope when the input value is in the negative range in the activation function of the neural network, as one of optimization parameters.

Another aspect of the present invention is a data processing method. This method includes: outputting, executing a process according to a neural network on learning data, output data corresponding to the learning data; and optimizing an optimization target parameter of the neural network on the basis of a comparison between the output data corresponding to the learning data and ideal output data for the learning data, wherein the optimizing an optimization target parameter optimizes a slope ratio parameter indicating a ratio between a slope when an input value is in a positive range and a slope when the input value is in a negative range of an activation function of the neural network, as one of optimization parameters.

Note that any combination of the above constituent elements, and representations of the present invention converted between a method, a device, a system, a recording medium, a computer program, or the like, are also effective as an aspect of the present invention.

### BRIEF DESCRIPTION OF THE DRAWINGS

Embodiments will now be described, byway of example only, with reference to the accompanying drawings that are meant to be exemplary, not limiting, and wherein like elements are numbered alike in several figures, in which:

FIG. 1 is a block diagram illustrating functions and configurations of a data processing system according to an embodiment;

FIG. 2 is a diagram illustrating a flowchart of a learning process performed by a data processing system; and

FIG. 3 is a diagram illustrating a flowchart of an application process performed by the data processing system.

### DETAILED DESCRIPTION OF THE INVENTION

The invention will now be described by reference to the preferred embodiments. This does not intend to limit the scope of the present invention, but to exemplify the invention.

Hereinafter, the present invention will be described based on preferred embodiments with reference to the drawings.

Hereinafter, an exemplary case where the data processing device is applied to image processing will be described. It will be understood by those skilled in the art that the data processing device can also be applied to voice recognition processing, natural language processing, and other processes.

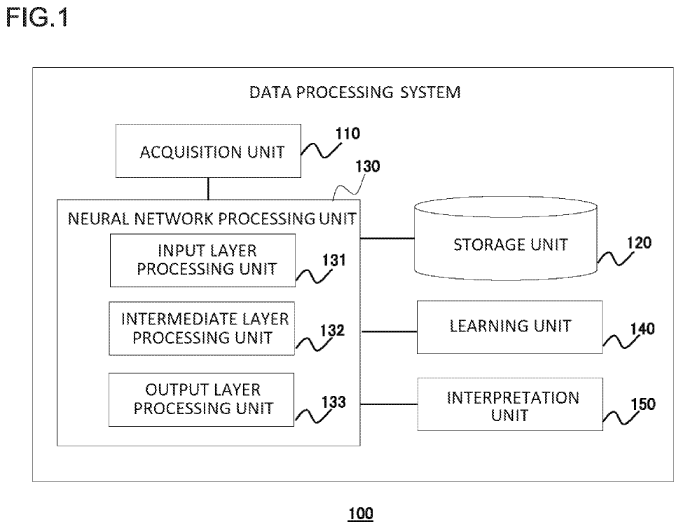

FIG. 1 is a block diagram illustrating functions and configurations of a data processing system 100 according to an embodiment. Each of blocks illustrated here can be implemented by elements or mechanical device such as a central processing unit (CPU) of a computer in terms of hardware, and can be implemented by a computer program in terms of software. However, functional blocks implemented by cooperation of hardware and software are depicted here. Accordingly, implementability of these functional blocks in various forms using the combination of hardware and software would be understandable by those skilled in the art.

The data processing system 100 executes a “learning process” of performing neural network learning based on a training image and a ground truth that is ideal output data for the image and an “application process” of applying a trained neural network on an image and performing image processing such as image classification, object detection, or image segmentation.

In the learning process, the data processing system 100 executes a process according to the neural network on the training image and outputs output data for the training image. Subsequently, the data processing system 100 updates the optimization (learning) target parameter of the neural network (hereinafter referred to as “optimization target parameter”) so that the output data approaches the ground truth. By repeating this, the optimization target parameter is optimized.

In the application process, the data processing system 100 uses the optimization target parameter optimized in the learning process to execute a process according to the neural network on the image, and outputs the output data for the image. The data processing system 100 interprets output data to classify the image, detect an object in the image, or apply image segmentation on the image.

The data processing system 100 includes an acquisition unit 110, a storage unit 120, a neural network processing unit 130, a learning unit 140, and an interpretation unit 150. The functions of the learning process are implemented mainly by the neural network processing unit 130 and the learning unit 140, while the functions of the application process are implemented mainly by the neural network processing unit 130 and the interpretation unit 150.

In the learning process, the acquisition unit 110 acquires at one time a plurality of training images and the ground truth corresponding to each of the plurality of images. Furthermore, the acquisition unit 110 acquires an image as a processing target in the application process. The number of channels is not particularly limited, and the image may be an RGB image or a grayscale image, for example.

The storage unit 120 stores the image acquired by the acquisition unit 110 and also serves as a working area for the neural network processing unit 130, the learning unit 140, and the interpretation unit 150 as well as a storage for parameters of the neural network.

The neural network processing unit 130 executes processes according to the neural network. The neural network processing unit 130 includes: an input layer processing unit 131 that executes a process corresponding to each of components of an input layer of the neural network; an intermediate layer processing unit 132 that executes a process corresponding to each of components of each of layers of one or more intermediate layers (hidden layers): and an output layer processing unit 133 that executes a process corresponding to each of components of an output layer.

The intermediate layer processing unit 132 executes an activation process of applying an activation function to input data from a preceding layer (input layer or preceding intermediate layer) as a process on each of components of each of layers of the intermediate layer. The intermediate layer processing unit 132 may also execute a convolution process, a pooling process, and other processes in addition to the activation process.

The activation function is given by the following Formula (1).

$$f ( {x}_{c} ) = \{ \begin{matrix}\frac{{x}_{c}}{max ( 1 , {k}_{c} )} & ( {x}_{c} \geq 0 ) \\ \frac{{x}_{c}}{max ( 1 , \frac{1}{{k}_{c}} )} & ( {x}_{c} < 0 )\end{matrix} \qquad ( 1 )$$

Here, k_{c} is a parameter indicating a ratio of the slope when the input value is in the positive range and the slope when the input value is in the negative range (hereinafter, referred to as a “slope ratio parameter”). The slope ratio parameter k_{c} is set independently for each of components. For example, a component is a channel of input data, coordinates of input data, or input data itself.

The output layer processing unit 133 performs an operation that combines a softmax function, a sigmoid function, and a cross entropy function, for example.

The learning unit 140 optimizes the optimization target parameter of the neural network. The learning unit 140 calculates an error using an objective function (error function) that compares an output obtained by inputting the training image into the neural network processing unit 130 and a ground truth corresponding to the image. The learning unit 140 calculates the gradient of the parameter by using the gradient backpropagation method or the like based on the calculated error as described in non-patent document 1 and then updates the optimization target parameter of the neural network based on the momentum method. The optimization target parameter includes the slope ratio parameter k_{c} in addition to the weights and the bias. Note that the initial value of the slope ratio parameter k_{c} is set to “1”, for example.

The process performed by the learning unit 140 will be specifically described using an exemplary case of updating the slope ratio parameter k_{c}.

Based on the gradient backpropagation method, the learning unit 140 calculates the gradient for the slope ratio parameter k_{c} of the objective function ε of the neural network by using the following Formula (2).

$$\frac{\partial ɛ}{\partial {k}_{c}} = {\sum }_{{x}_{c}} \frac{\partial ɛ}{\partial f ( {x}_{c} )} \frac{\partial f ( {x}_{c} )}{\partial {k}_{c}} \qquad ( 2 )$$

Here, ∂ε/∂f (x_{c}) is the back-propagated gradient from subsequent layers.

The learning unit 140 calculates the gradients ∂f(x_{c})/∂x_{c} and ∂f(x_{c})/∂k_{c} for the input x_{c} in each of components of each of layers of the intermediate layer and for each of slope ratio parameters k_{c} by using the following formulas (3) and (4), respectively.

$$\begin{matrix}\frac{\partial f ( {x}_{c} )}{\partial {x}_{c}} = \{ \begin{matrix}\frac{1}{max ( 1 , {k}_{c} )} , & if 0 \leq {x}_{c} \\ \frac{1}{max ( 1 , \frac{1}{{k}_{c}} )} , & else\end{matrix} & ( 3 ) \\ \frac{\partial f ( {x}_{c} )}{\partial {x}_{c}} = \{ \begin{matrix}- \frac{1}{{x}_{c}^{2}} , & if 0 \leq {x}_{c} and {k}_{c} \geq 1 \\ {x}_{c} & if {x}_{c} < 0 and {k}_{c} < 1 \\ 0 , & else\end{matrix} & ( 4 )\end{matrix}$$

The learning unit 140 updates the slope ratio parameters k_{c} by the momentum method (Formula (5) below) based on the calculated gradient.

$$Δ {k}_{c} := μΔ {k}_{c} + η \frac{\partial ɛ}{\partial {k}_{c}} \qquad ( 5 )$$

Here,

μ: momentum

η: learning rate

For example, μ=0.9 and η=0.1 will be used as the setting.

The optimization target parameter will be optimized by repeating the acquisition of the training image by the acquisition unit 110, the process according to the neural network for the training image by the neural network processing unit 130, and the updating of the optimization target parameter by the learning unit 140.

The learning unit 140 also determines whether to end the learning. Examples of the ending conditions for ending the learning include a case in which the learning has been performed a predetermined number of times, a case in which an end instruction has been received from the outside, a case in which the mean value of the update amount of the optimization target parameter has reached a predetermined value, or a case in which the calculated error falls within a predetermined range. The learning unit 140 ends the learning process when the ending condition is satisfied. In a case where the ending condition is not satisfied, the learning unit 140 returns the process to the neural network processing unit 130.

The interpretation unit 150 interprets the output from the output layer processing unit 133 and performs image classification, object detection, or image segmentation.

Operation of the data processing system 100 according to an embodiment will be described.

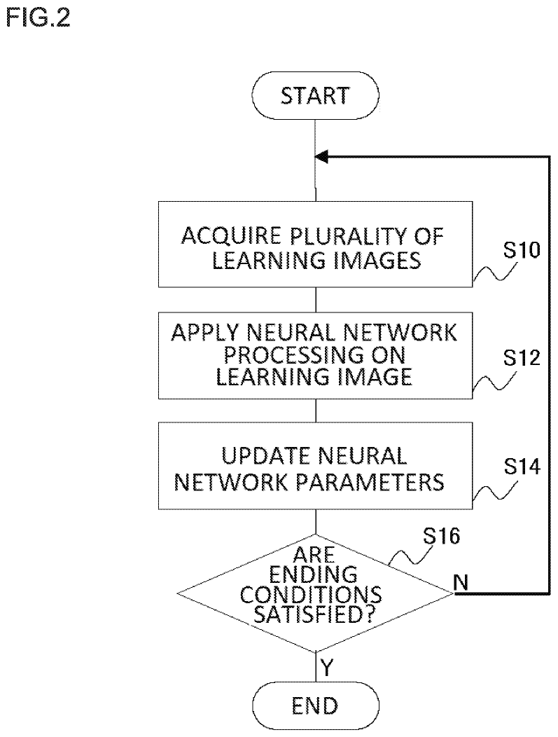

FIG. 2 illustrates a flowchart of the learning process performed by the data processing system 100. The acquisition unit 110 acquires a plurality of training images (S10). The neural network processing unit 130 performs processing according to the neural network on each of the plurality of training images acquired by the acquisition unit 110 and achieves output of output data for each of the images (S12). The learning unit 140 updates the parameters based on the output data and the ground truth for each of the plurality of training images (S14). In updating this parameter, the slope ratio parameter k_{c} is also updated as an optimization target parameter in addition to the weights and the bias. The learning unit 140 determines whether the ending condition is satisfied (S16). In a case where the ending condition is not satisfied (N in S16), the process returns to S10. In a case where the ending condition is satisfied (Y in S16), the process ends.

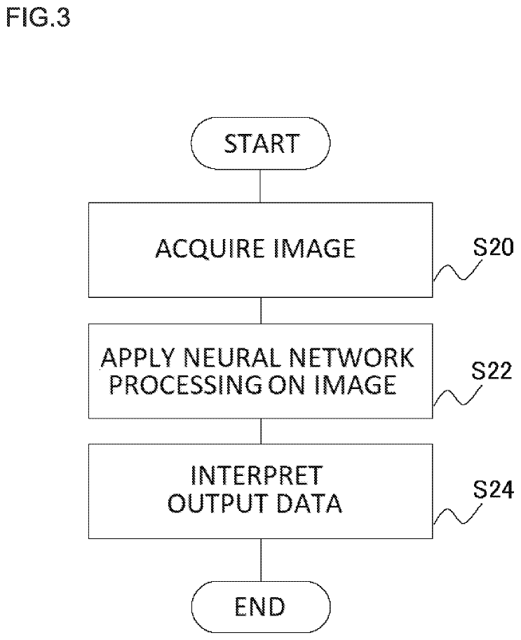

FIG. 3 illustrates a flowchart of the application process performed by the data processing system 100. The acquisition unit 110 acquires the image as an application processing target (S20). The neural network processing unit 130 executes, on the image acquired by the acquisition unit 110, processing according to the neural network in which the optimization target parameter is optimized, that is, the trained neural network, and then outputs output data (S22). The interpretation unit 150 interprets the output data, applies image classification on the target image, detects an object from the target image, or performs image segmentation on the target image (S24).

According to the data processing system 100 of the embodiment described above, the ratio of the slope of the activation function when the input value is in the positive range and the slope of the activation function when the input value is in the negative range is defined as an optimization target parameter, and the larger slope is to be fixed to 1. This makes it possible to achieve stabilization of learning.

The present invention has been described with reference to the embodiments. The present embodiment has been described merely for exemplary purposes. Rather, it can be readily conceived by those skilled in the art that various modification examples may be made by making various combinations of the above-described components or processes, which are also encompassed in the technical scope of the present invention.

What is claimed is:

1. A data processing system comprising a processor that includes hardware,
wherein the processor is configured to:
optimize an optimization target parameter of a neural network on the basis of comparison between output data that is output by executing a process according to the neural network on learning data and ideal output data for the learning data;
optimize a slope ratio parameter indicating a ratio of a slope when an input value is in a positive range and a slope when the input value is in a negative range in an activation function of the neural network, as one of optimization parameters,
the activation function is expressed by
$$f ( x ) = \{ \begin{matrix}\frac{x}{max ( 1 , k )} & ( x \geq 0 ) \\ \frac{x}{max ( 1 , \frac{1}{k} )} & ( x < 0 )\end{matrix} ,$$
and
k is a slope ratio parameter.

2. The data processing system according to claim 1,
wherein the processor is configured to set an initial value of the slope ratio parameter to 1.

3. The data processing system according to claim 1,
wherein the neural network is a convolutional neural network and has a slope ratio parameter that is independent for each of components.

4. The data processing system according to claim 3,
wherein the component is a channel.

5. A data processing method comprising:
outputting, by executing a process according to a neural network on learning data, output data corresponding to the learning data; and
optimizing an optimization target parameter of the neural network on the basis of a comparison between the output data corresponding to the learning data and ideal output data for the learning data,
wherein the optimizing an optimization target parameter optimizes a slope ratio parameter indicating a ratio of a slope when an input value is in a positive range and a slope when the input value is in a negative range in an activation function of the neural network, as one of optimization parameters,
the activation function is expressed by
$$f ( x ) = \{ \begin{matrix}\frac{x}{max ( 1 , k )} & ( x \geq 0 ) \\ \frac{x}{max ( 1 , \frac{1}{k} )} & ( x < 0 )\end{matrix} ,$$
and
k is a slope ratio parameter.

6. A non-transitory computer readable medium encoded with a program executable by a compute, the program comprising:
optimizing an optimization target parameter of a neural network on the basis of comparison between output data that is output by executing a process according to the neural network on learning data and ideal output data for the learning data,
the optimizing an optimization target parameter optimizes a slope ratio parameter indicating a ratio of a slope when an input value is in a positive range and a slope when the input value is in a negative range in an activation function of the neural network, as one of optimization parameters, and
the activation function is expressed by
$$f ( x ) = \{ \begin{matrix}\frac{x}{max ( 1 , k )} & ( x \geq 0 ) \\ \frac{x}{max ( 1 , \frac{1}{k} )} & ( x < 0 )\end{matrix} ,$$
and
k is a slope ratio parameter.
